(19) United States
(12) Patent Application Publication
(10) Pub. No.: US 2025/0140131 A1
(43) Pub. Date: May 1, 2025

(54) NECK, HIP, CENTRAL VENOUS LINE, GASTRONOMY SITE, AND POWER PLATE COMPONENTS FOR PATIENT SIMULATORS

(71) Applicant: GAUMARD SCIENTIFIC COMPANY, INC., Miami, FL (US)

(72) Inventors: Alejandro CABALLE, Miami, FL (US); Alfredo HERNANDEZ, Miami, FL (US); Alayn GONZALEZ, Miami, FL (US)

(21) Appl. No.: 18/933,416

(22) Filed: Oct. 31, 2024

Related U.S. Application Data
(60) Provisional application No. 63/594,936, filed on Oct. 31, 2023.

(51) Int. Cl. G09B 23/32; G09B 23/28; G09B 23/34

(52) U.S. Cl. CPC G09B 23/32; G09B 23/285; G09B 23/34

(57) ABSTRACT

Systems, apparatuses, and methods are provided for patient simulators and assemblies for patient simulators. Patient simulators may include neck assemblies, hip assemblies, gastronomy assemblies, power plate assemblies, and central venous line and insert assemblies. A neck assembly may include one or more joints. A hip assembly may include one or more joints. A gastronomy assembly may include a gastric port, colostomy port, and a gastric reservoir. A power plate assembly may include a power controller, power indicator, and one or more connectors. Central venous line and insert assemblies may include a simulated catheter connected to a first and second port of a patient simulator. A central line insert assembly may include a subclavian insert, a plurality of tubing including a plurality of lumens, and a plurality of luer caps and luer connectors.

### CROSS-REFERENCE TO RELATED APPLICATIONS

The present application claims the benefit of the filing date, and priority to, U.S. Provisional Application No. 63/594,936 filed Oct. 31, 2023, the disclosure of which is hereby incorporated herein by reference.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. patent application Ser. No. 11/952,559 (Publication No. 20080138778), U.S. patent application Ser. No. 11/952,606 (Publication No. 20080131855), U.S. patent application Ser. No. 11/952,636 (Publication No. 20080138779), U.S. patent application Ser. No. 11/952,669 (Publication No. 20090148822), U.S. patent application Ser. No. 11/952,698 (Publication No. 20080138780), U.S. Pat. Nos. 7,114,954, 6,758,676, 6,503,087, 6,527,558, 6,443,735, 6,193,519, 5,853,292, and 11,756,451 each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes neck assemblies, hip assemblies, central venous lines, gastrostomy assemblies, and power plate assemblies. The neck assembly described herein may have sufficient articulations to allow a head of a patient simulator to rotate, move side-to-side, and move back and forth. The hip assembly described herein may have sufficient articulations to allow the patient simulator to be positioned in stirrups, sit upright unassisted, and have crossed legs. In some instances, central veinous lines and gastrostomy assemblies have increased functionality for simulating more procedures and tasks and mimicking the processes of the human body. In some aspects the power plate assembly comprises one or more lights to indicate patient simulator status information, such as battery's charge, status of communication connectivity, type of communication, indicate critical failure. In some aspects, a push button may be used to wake up the patient simulator, determine the status of the battery charge, and change the type of communication.

In one general aspect, the present disclosure is directed to a neck assembly for a patient simulator. The neck assembly also includes a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In one general aspect, the present disclosure is directed to a patient simulator. The patient simulator also includes a simulated head; a simulated torso; and a neck assembly, including: a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In one general aspect, the present disclosure is directed to a method for assembling a patient simulator. The method also includes connecting a neck assembly to simulated head of the patient simulator; and connecting the neck assembly to a simulated torso of the patient simulator, where the neck assembly includes: a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In one general aspect, the present disclosure is directed to a hip assembly for a patient simulator. The hip assembly also includes a first portion and a second portion, where the first portion is mounted to a simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg portion in a frontal plane of the patient simulator, and where the second portion that may include a second joint, where the second joint is configured to rotate around a third axis to cause movement of the simulated leg portion in a transverse plane.

In one general aspect, the present disclosure is directed to a patient simulator. The patient simulator also includes a simulated torso and a simulated leg, where the simulated leg includes a hip assembly configured to control positioning and orientation of the simulated leg, where the hip assembly includes: a first portion and a second portion, where the first portion is mounted to the simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg in a frontal plane of the patient simulator, and where the second portion that may include a second joint, where the second joint is configured to rotate around a third axis to cause movement of the simulated leg portion in a transverse plane.

In one general aspect, the present disclosure is directed to a method for assembling a patient simulator. The method also includes connecting a first portion of a hip assembly within a simulated leg to a simulated torso of the patient simulator, where the hip assembly is configured to control positioning and orientation of the simulated leg and includes: a first portion and a second portion, where the first portion is mounted to the simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg in a frontal plane of the patient simulator, and where the second portion that may include a second joint, where the second joint is configured to rotate around a third axis to cause movement of the simulated leg portion in a transverse plane.

In one general aspect, the present disclosure is directed to a gastronomy assembly for a patient simulator. The gastronomy assembly also includes a gastric reservoir bracket configured to be attached to an internal wall of a simulated torso of the patient simulator; a gastric reservoir connected to the bracket and configured to store simulated gastric fluids, and a gastric port connected to the gastric reservoir and configured to allow simulated gastric fluids to pass through the gastric port into the gastric reservoir.

In one general aspect, the present disclosure is directed to a patient simulator. The patient simulator also includes a simulated torso; and a gastronomy assembly mounted to an internal wall of the simulated torso, the gastronomy assembly including: a gastric reservoir bracket connected to an internal wall of a simulated torso of the patient simulator; a gastric reservoir affixed to the bracket and configured to store simulated gastric fluids; and a gastric port connected to the gastric reservoir and configured to allow simulated gastric fluids to pass through the gastric port into the gastric reservoir.

In one general aspect, the present disclosure is directed to a power plate assembly for a patient simulator. The power plate assembly also includes a power plate; a power controller affixed to the power plate. The power plate assembly also includes a power indicator affixed to the power plate; and one or more mating connectors to receive one or more connectors, the one or more mating connectors affixed to the power plate. The power plate assembly also includes where the one or more connectors include a connector configured to establish communication between the patient simulator and a computing device.

In one general aspect, the present disclosure is directed to patient simulator. The patient simulator also includes a battery disposed within the patient simulator; a simulated torso. The patient simulator also includes a power plate assembly mounted on the simulated torso and connected to the battery, that may include: a power plate; a power controller affixed to the power plate; a power indicator affixed to the power plate; and one or more mating connectors to receive one or more connectors, the one or more mating connectors affixed to the power plate, where the one or more connectors include a connector configured to establish communication between the patient simulator and a computing device.

In one general aspect, the present disclosure is directed to a central venous line assembly configured for placement in an internal cavity of a simulated torso of a patient simulator. The central venous line assembly also includes a first port; a simulated catheter that may include a tube connected at a first end to the first port; and a second port connected to a second end of the tube, where the central venous line assembly is configured to allow fluid communication between the first port and the second port.

In one general aspect, the present disclosure is directed to a patient simulator. The patient simulator also includes a simulated torso that includes a first port, and a second port. The patient simulator also includes a central venous line assembly configured for placement in an internal cavity of the simulated torso. The central venous line assembly includes a simulated catheter that may include a tube, where a first end of the tube is connected to the first port of the simulated torso, and where a second end of the tube is connected to second port of the simulated torso, where the central venous line assembly is configured to allow fluid communication between the first port and the second port.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator, according to one or more aspects of the present disclosure.

FIG. 2A is a perspective view of a neck assembly, according to one or more aspects of the present disclosure.

FIG. 2B is an exploded view of the neck assembly of FIG. 2A, according to one or more aspects of the present disclosure.

FIG. 3 is a perspective view of a portion of a patient simulator, according to one or more aspects of the present disclosure.

FIG. 4 is a perspective view of a hip joint assembly, according to one or more aspects of the present disclosure.

FIG. 5 is an exploded view of the hip joint assembly of FIG. 4, according to one or more aspects of the present disclosure.

FIG. 6 is a perspective view of a gastric and/or colostomy assembly, according to one or more aspects of the present disclosure.

FIG. 7 is a plurality of exploded views of a gastric and/or colostomy assembly, according to one or more aspects of the present disclosure.

FIG. 8 is a schematic diagram of the pneumatics of a gastric and/or colostomy assembly, according to one or more aspects of the present disclosure.

FIG. 9 is a perspective view of a portion of a patient simulator, according to one of more aspects of the present disclosure.

FIG. 10 is a perspective view of a power plate assembly, according to one or more aspects of the present disclosure.

FIG. 11 is an exploded view of a power plate assembly, according to one or more aspects of the present disclosure.

FIG. 12 is plurality of views of a push button of a power plate assembly, according to one of more aspects of the present disclosure.

FIG. 13 is an exploded view of a board of a power plate assembly, according to one or more aspects of the present disclosure.

FIG. 14 is a cross-sectional side view of a portion of a patient simulator, according to one of more aspects of the present disclosure.

FIG. 15 is a cross-sectional view of a central venous line assembly in the lower torso of a patient simulator, according to one or more aspects of the present disclosure.

FIG. 16 is a perspective view of a central venous line assembly, according to one or more aspects of the present disclosure.

FIG. 17 is a perspective view of a multi-lumen central line insert assembly, according to one or more aspects of the present disclosure.

FIG. 18 is a plurality of views of a subclavian insert, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

Generally, the present disclosure describes neck assemblies, hip assemblies, central venous lines, gastrostomy assemblies, and power plate assemblies. For example, neck and hip assemblies allow for a greater degree of actuation and positioning of a patient simulator, central venous lines for more simulated care tasks, gastrostomy assemblies for the ability to remove or introduce fluids, and power plate assemblies for monitoring and operating the patient simulator. The neck assembly described herein may have sufficient articulations to allow a head of a patient simulator to rotate, move side-to-side, and move back and forth. The hip assembly described herein may have sufficient articulations to allow the patient simulator to be positioned in stirrups, sit upright unassisted, and have crossed legs. In some aspects the power plate assembly comprises one or more lights to indicate patient simulator status information, such as battery's charge, status of communication connectivity, type of communication, indicate critical failure. Furthermore, a push button may be used to wake up the patient simulator, determine the status of the battery charge, and change the type of communication. Because patient examination vary for different systems of the body simulators a greater number of simulation are necessary to facilitate training through realistic examinations. Furthermore, it costly to use special purpose simulators each and every form of examination or diagnostic.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulator disclosed herein provides a system that is readily expandable and updatable without large expense and that enables users to learn comprehensive medical and surgical skills through “hands-on” training, without sacrificing the experience gained by users in using standard surgical instruments in a simulated patient treatment situation.

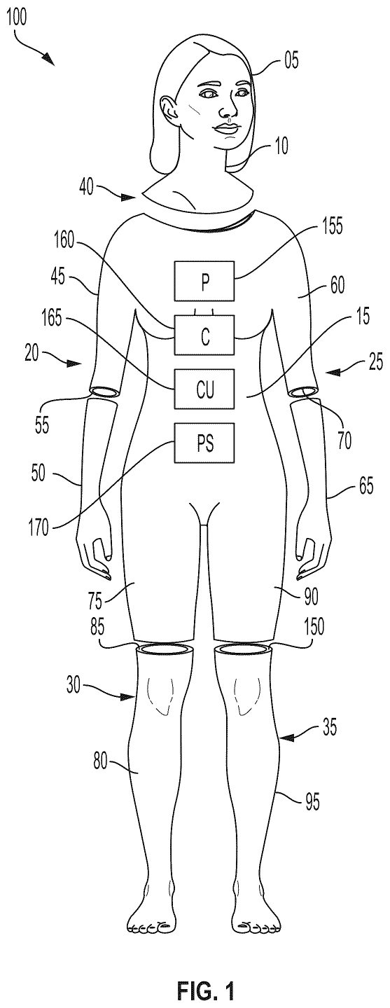

Referring to FIG. 1, in one aspect, a patient simulator is generally referred to by the reference numeral 100 and includes a simulated head 05, a simulated neck 10, a simulated torso 15, a simulated right arm 20 (or “extremity”), a simulated left arm 25 (or “extremity”), a simulated right leg 30 (or “extremity”), and a simulated left leg 35 (or “extremity”). In several aspects, the patient simulator is, includes, or is part of, a manikin. The simulated head 05 is coupled to the simulated neck 10; for example, the simulated head 05 may be integrally formed with the simulated neck 10. The patient simulator 100 further includes a head coupling 40. The simulated neck 10 is adapted to be detachably coupled to the simulated torso 15 via the head coupling 40. The simulated right arm 20 includes a simulated upper right arm 45 (or “extremity”) and a simulated lower right arm 50 (or “extremity”). The simulated upper right arm 45 is coupled to the simulated torso 15; for example, the simulated upper right arm 45 may be integrally formed with the simulated torso 15. The simulated right arm 20 further includes a right arm coupling 55 (or “extremity coupling”). The simulated lower right arm 50 is adapted to be detachably coupled to the simulated upper right arm 45 via the right arm coupling 55. Similarly, the simulated left arm 25 includes a simulated upper left arm 60 (or “extremity”) and a simulated lower left arm 65 (or “extremity”). The simulated upper left arm 60 is coupled to the simulated torso 15; for example, the simulated upper left arm 60 may be integrally formed with the simulated torso 15. The simulated left arm 25 further includes a left arm coupling 70 (or “extremity coupling”). The simulated lower left arm 65 is adapted to be detachably coupled to the simulated upper left arm 60 via the left arm coupling 70.

The simulated right leg 30 includes a simulated upper right leg 75 (or “extremity”) and a simulated lower right leg 80 (or “extremity”). The simulated upper right leg 75 is coupled to the simulated torso 15; for example, the simulated upper right leg 75 may be integrally formed with the simulated torso 15. The simulated right leg 30 further includes a right leg coupling 85 (or “extremity coupling”). The simulated lower right leg 80 is adapted to be detachably coupled to the simulated upper right leg 75 via the right leg coupling 85. Similarly, the simulated left leg 35 includes a simulated upper left leg 90 (or “extremity”) and a simulated lower left leg 95 (or “extremity”). The simulated upper left leg 90 is coupled to the simulated torso 15; for example, the simulated upper left leg 90 may be integrally formed with the simulated torso 15. The simulated left leg 35 further includes a left leg coupling 150 (or “extremity coupling”). The simulated lower left leg 95 is adapted to be detachably coupled to the simulated upper left leg 90 via the left leg coupling 150.

The simulated torso 15 contains a pump 155, a compressor 160, a control unit 165, and a power source 170. The compressor 160 is adapted to supply pneumatic pressure to various features/components of the patient simulator 100; such features/components to which pneumatic pressure is supplied by the compressor 160 may be contained in the simulated torso 15, the simulated head 05, the simulated right arm 20, the simulated left arm 25, the simulated right leg 30, and/or the simulated left leg 35. In several aspects, the compressor 160 is a scroll compressor. The pump 155 is adapted to supply hydraulic pressure to various features/components of the patient simulator 100; such features/components to which hydraulic pressure is supplied by the pump 155 may be contained in the simulated torso 15, the simulated head 05, the simulated right arm 20, the simulated left arm 25, the simulated right leg 30, and/or the simulated left leg 35.

The control unit 165 is adapted to control the compressor 160, the pump 155, and various other features/components of the patient simulator 100; such other features/components controlled by the control unit 165 may be contained in the simulated torso 15, the simulated head 05, the simulated right arm 20, the simulated left arm 25, the simulated right leg 30, and/or the simulated left leg 35. The power source 170 is adapted to supply electrical power to the compressor 160, the pump 155, the control unit 165, and various other features/components of the patient simulator 100; such other features/components to which electrical power is supplied by the power source 170 may be contained in the simulated torso 15, the simulated head 05, the simulated right arm 20, the simulated left arm 25, the simulated right leg 30, and/or the simulated left leg 35.

In one or more aspects, the simulated torso 15 shown in FIG. 1 may be divided into a simulated upper torso and a simulated lower torso. In such instances: the simulated upper right arm 45 and the simulated upper left arm 60 are coupled to the simulated upper torso—for example, the simulated upper right arm 45 and the simulated upper left arm 60 may be integrally formed with the simulated upper torso; the simulated upper right leg 75 and the simulated upper left leg 90 are coupled to the simulated lower torso—for example, the simulated upper right leg 75 and the simulated upper left leg 90 may be integrally formed with the simulated lower torso; and the simulated torso 15 further includes a torso coupling via which the simulated upper torso is adapted to be detachably coupled to the simulated lower torso. In one or more aspects, simulated torso may include attachable/detachable simulated left breast and axilla region. In one or more aspects, simulated torso may include attachable/detachable simulated right breast and axilla region.

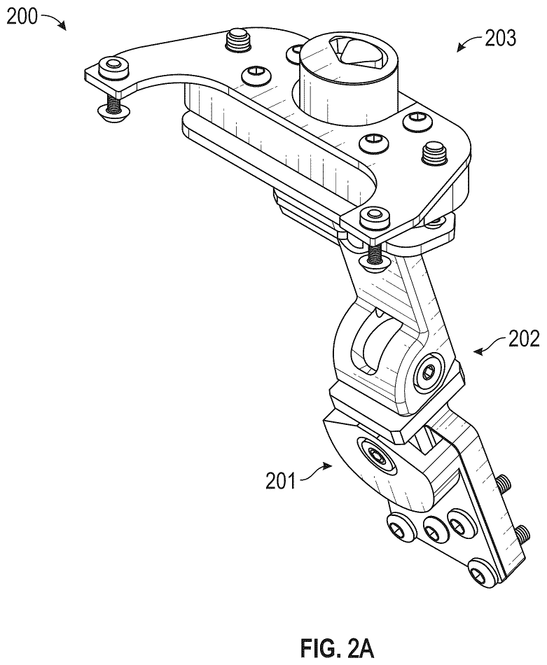

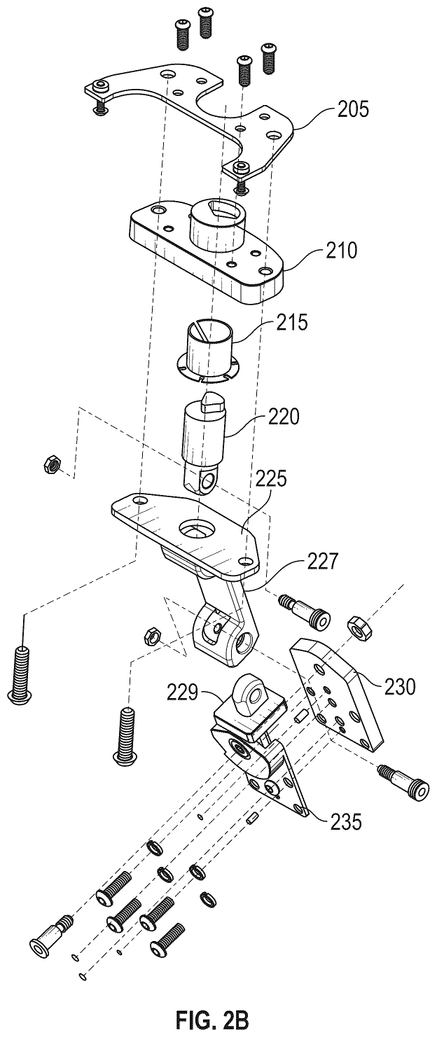

Referring to FIG. 2A, is a perspective view of a neck assembly, according to one or more aspects of the present disclosure. The neck assembly 200 may include a number of joints. Head-rotation joint 203 may facilitate the rotation of a head of a patient simulator, i.e., rotation in a transverse plane of a patient simulator. Sagittal joint 202 may facilitate movement of a head of a patient simulator in the sagittal plane of the patient simulator. Frontal joint 201 may facilitate movement of a head of a patient simulator in the frontal plane of the patient simulator. Combinations of movements of any subset of the joints 201, 202, or 203 may done sequentially or simultaneously.

Each of the planes, transverse, sagittal, and frontal, may be defined or associated with an axis of rotation perpendicular to the planes. Each axis of rotation may represent a degree of freedom for a patient simulator representative of a degree of freedom in human anatomy. To better simulate the movement of human anatomy one or more joints may be restricted in their range of motion. Thus, a head-rotation joint 203 may be restricted to move within a range of angles less than 360 degrees around the axis of the transverse plane. In some aspects, a head-rotation joint may be configured to rotate through a range of angles between 150 and 190 degrees. In some aspects, a sagittal joint 202, facilitating neck flexion and extension, may be configured to rotate between 60-90 degrees for flexion and 45-60 degrees for extension, i.e., a total angle of 105 to 150 degrees. In some aspects, a frontal joint 201, facilitating lateraling bending of the neck, may be configured to rotate between 30 and 45 degrees to each side, i.e., a total angle of 60-90 degrees.

In some aspects, a neck assembly may include one or more of the joints discussed above, which may be representative of joints in human anatomy. Each of the joints 201, 202, and/or 203 may be selectively actuated such that a position and orientation of the neck assembly may be set by a user without movement after setting. The frontal joint 201, sagittal joint 202, and/or head-rotating joint 203 may comprise one or more individual mechanical components, e.g., as shown in the exploded view of FIG. 2B and described below.

In some aspects, neck assembly 200 may be mounted or otherwise attached to a simulated head of a patient simulator 100 and/or simulated torso 15 (e.g., a simulated upper torso) of a patient simulator 100. A head-rotation joint 203 may include mounting or attaching means for attaching a neck assembly 200 to a simulated head of a patient simulator. A frontal joint 201 may include mounting or attaching means for attaching a neck assembly 200 to a simulated torso of a patient simulator. In some aspects, neck assembly 200 may be sized for patient simulators representative of human anatomy of various sizes and maturities, e.g., tall or short simulators and infant-sized, child-sized, adolescent-sized, and adult-sized patient simulators.

Referring to FIG. 2B, shown therein is an exploded view of the neck assembly of FIG. 2A, according to one or more aspects of the present disclosure. FIG. 2B depicts a head-neck plate bracket 205, head-neck sleeve bearing 210, flanged bearing 215, head-neck shaft 220, head-neck plate 225, first neck link 227, second neck link 229, third neck link 230, and fourth neck link 235. A head-neck plate bracket 205, head-neck sleeve bearing 210, flanged bearing 215, head-neck shaft 220, head-neck plate 225, first neck link 227, second neck link 229, third neck link 230, and fourth neck link 235 may assembled as shown in FIG. 2B. In some aspects, head-neck plate bracket 205 may be fastened to a simulated head using screws as shown in FIG. 2B. In some aspects, third neck link 230 and/or fourth neck link 235 may be fastened to a simulated torso (e.g., simulated upper torso) using screws as shown in FIG. 2B. A first portion of the neck assembly may move as a frontal joint 201 and include one or more of a second neck link 229, third neck link 230, and/or fourth neck link 235. A second portion of the neck assembly 200 may move as a sagittal joint 202 and include one or more of a second neck link 229, a first neck link 227, and/or head-neck plate 225. A third portion of the neck assembly 200 may move as a head-rotation joint 203 and include one or more of head-neck plate 225, head-neck shaft 220, flanged bearing 215, head-neck sleeve bearing 210, and/or head-neck plate bracket 205.

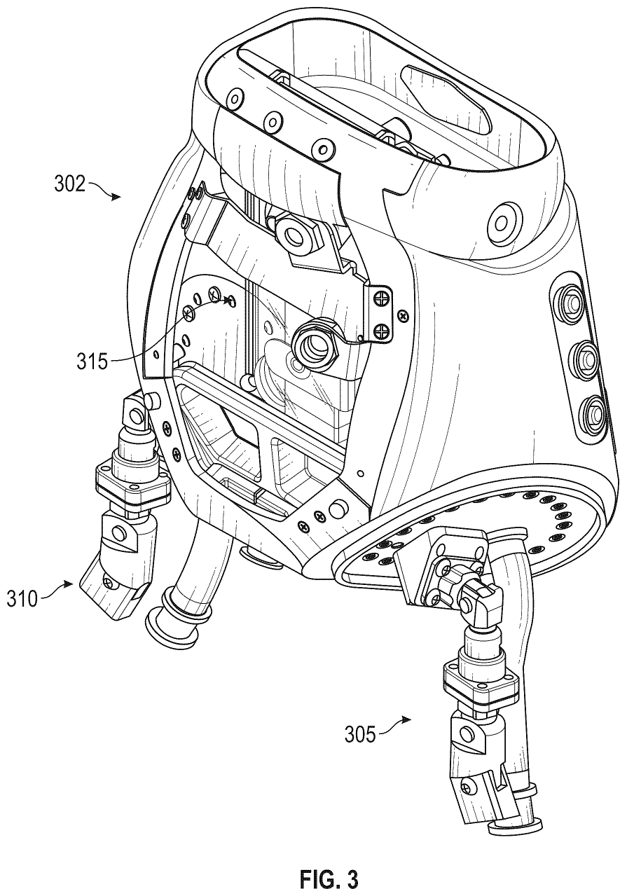

Referring to FIG. 3, shown therein is a perspective view of a portion of a patient simulator, according to one or more aspects of the present disclosure. FIG. 3 includes a lower torso 302, left hip joint assembly 305, right hip joint assembly 310, and gastric and/or colostomy assembly 315. In some instances, hip joint assemblies 305 and 310 may allow a patient simulator to be placed in stirrups. This is advantageous for training on various procedures and examinations, e.g., gynecological and urological examinations and procedures. In some instances, hip joint assemblies 305 and 310 may allow a patient simulator to be configured for sitting in a chair and/or cross its legs. In some instances, gastric and/or colostomy assembly 315 may facilitate G-tube use and access for nursing care, including the ability to introduce or remove fluids. Gastric and/or colostomy assembly may allow a user to check placement and patency, aspirate stomach contents, and hear an audible “swoosh” when passing a small amount of air through a G-tube while utilizing a stethoscope to auscultate.

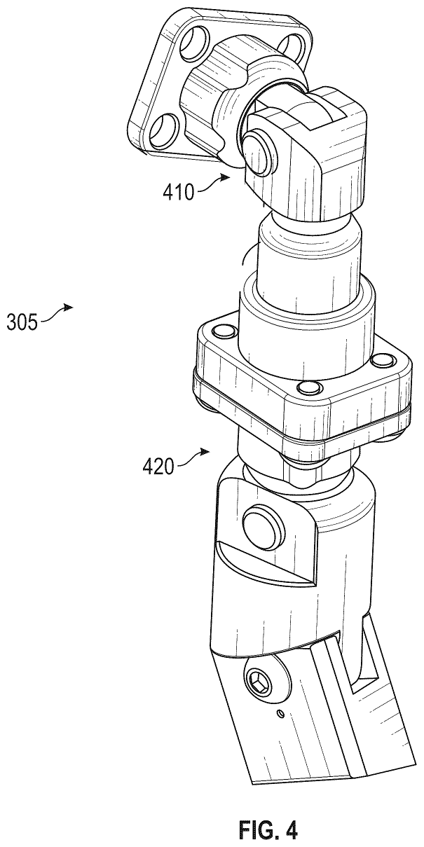

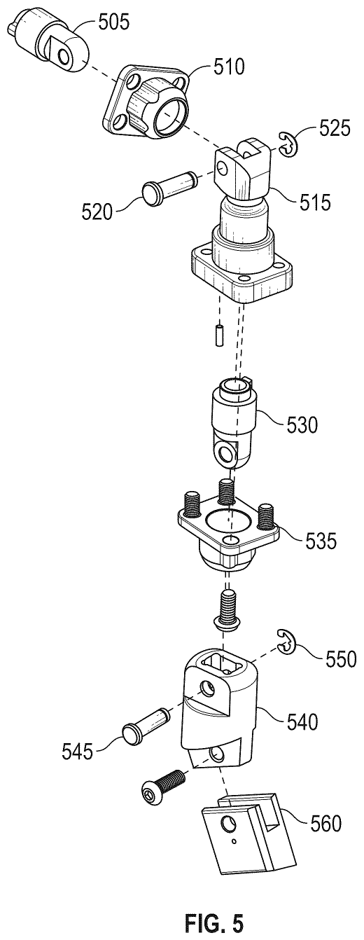

Referring to FIG. 4, shown therein is a perspective view of a hip joint assembly 305, according to one or more aspects of the present disclosure. FIG. 4 depicts a left hip joint assembly 305, and similar descriptions apply to a right hip joint assembly 310. Hip joint assembly 305 may include a first mechanical joint 410. In some instances, first mechanical joint 410 may be configured to rotate about a joint shaft's (depicted in FIG. 5, below) axis and/or to rotate the leg of a patient simulator around the leg's connection point to the joint shaft. Said another way, first mechanical joint 410 may allow movement of a simulated leg in a sagittal plane (i.e., flexion and extension) and a frontal plane (i.e., abduction and adduction). Second mechanical joint 420 may allow rotation of a simulated leg in a transverse plane (i.e., internal and external rotation). First mechanical joint 410 and second mechanical joint 420 may be considered as a single joint comprising all of the degrees of freedom of the hip.

Each of the planes, transverse, sagittal, and frontal, may be defined or associated with an axis of rotation perpendicular to the planes. Each axis of rotation may represent a degree of freedom for a patient simulator representative of a degree of freedom in human anatomy. To better simulate the movement of human anatomy one or more joints may be restricted in their range of motion. In some aspects, a first mechanical joint, facilitating hip flexion and hip extension, may be configured to rotate through a range of angles between 130 and 180 degrees—25-40 degrees for hip extension and 105-140 degrees for hip flexion. In some aspects, a first mechanical joint, facilitating hip abduction and hip adduction, may be configured to rotate through a range of angles between 55 and 90 degrees—15-35 degrees for adduction and 40-55 degrees for abduction. In some aspects, the second mechanical joint 420 may be restricted to move within a range of angles less than 180 degrees around the axis of the transverse plane. In some aspects, second mechanical joint, facilitating hip internal rotation and hip external rotation, may be configured to rotate between 35-50 degrees for internal rotation and 40-55 degrees for external rotation.

In some aspects, a hip assembly may include one or more of the joints discussed above, which may be representative of joints in human anatomy. Each of the joints 410 and/or 420 may be selectively actuated such that a position and orientation of the hip assembly may be set by a user after which the hip assembly holds the position set by the user. The first mechanical joint 410 and/or second mechanical joint may comprise one or more individual mechanical components, e.g., as shown in the exploded view of FIG. 5 and described below. Similar descriptions apply for both the left hip assembly and the right hip assembly.

In some aspects, hip assemblies 305 and 315 may be mounted or otherwise attached to a patient simulator 100, e.g., simulated torso 15 of the patient simulator 100. In some aspects, the hip assemblies may be attached to a simulated lower torso. A first mechanical joint 410 may include means for mounting or attaching hip assemblies 305, 310 to a simulated torso of a patient simulator. In some aspects, hip assemblies 305, 310 may be sized for patient simulators representative of human anatomy of various sizes and maturities, e.g., tall or short simulators, infant-sized, child-sized, adolescent-sized, and adult-sized patient simulators, etc.

Referring to FIG. 5, shown therein is an exploded view of the hip joint assembly of FIG. 4, according to one or more aspects of the present disclosure. FIG. 5 includes a first joint shaft 505, a hip joint shaft holder 510, a first upper leg bar 515, a pin 520, a retaining ring 525, a second joint shaft 530, a second hip join shaft holder 535, a second upper leg bar 540, a pin 545, a retaining ring 550, and a third upper leg bar 560. In some instances, a first joint shaft 505, a hip joint shaft holder 510, a first upper leg bar 515, a pin 520, a retaining ring 525, a second joint shaft 530, a second hip join shaft holder 535, a second upper leg bar 540, a pin 545, a retaining ring 550, and a third upper leg bar 560 may be assembled as depicted in FIG. 5. In some aspects, a hip joint shaft holder 510 may be attached to a simulated head using screws as shown in FIGS. 3 and 5. A first portion of the hip assembly may move as a first mechanical joint 410 and include one or more of, a first joint shaft 505, a hip joint shaft holder 510, a first upper leg bar 515, a pin 520, and/or a retaining ring 525. A second portion of the hip assembly 305 may move as a second mechanical joint 420 and include one or more of a first upper leg bar 515, second joint shaft 530, a second hip join shaft holder 535, a second upper leg bar 540, a pin 545, and/or a retaining ring 550. This assignment of components to each joint is merely exemplary—other groupings may be used.

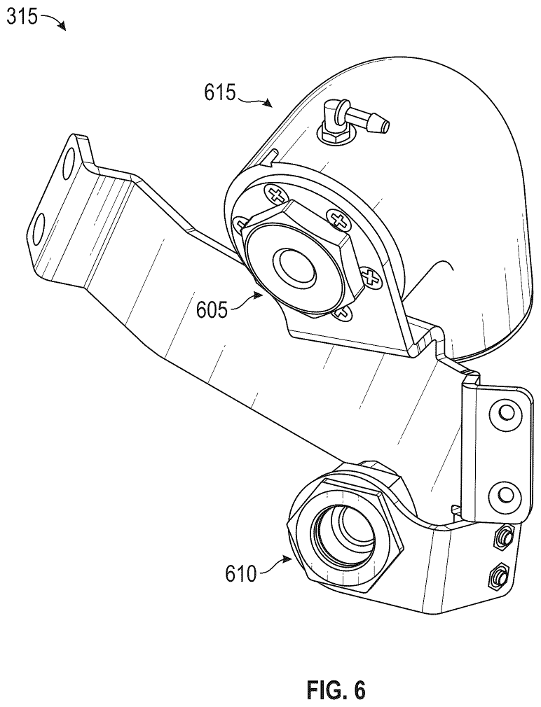

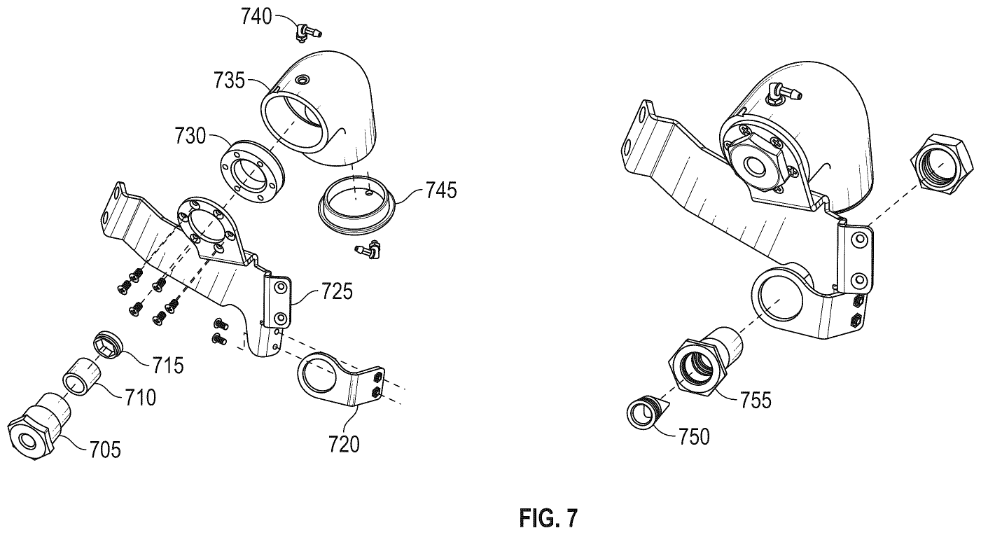

Referring to FIG. 6, shown therein is a perspective view of a gastric and/or colostomy assembly, according to one or more aspects of the present disclosure. In some instances, gastronomy assembly 315, which may also include a colostomy assembly, may include a gastric port 605, a colostomy port 610, and/or gastric reservoir 615. A gastric port 605 and colostomy port 610 may be rigidly attached to each other through use of brackets and fasteners, as depicted in FIG. 6 and FIG. 7, described below. In some instances, the brackets are further fastened to the interior/exterior of the abdominal wall or simulated torso of a patient simulator. Gastronomy assembly 315 may be configured to receive, transport, and/or store gastric fluids. Gastric fluids may move in both directions through gastric port 605 and colostomy port 610. Gastric port 605 is in fluid communication with gastric reservoir 615. In some aspects, gastric reservoir is configured to store between 50-100 mL of gastric fluids, e.g., a gastric reservoir may store 70 mL of gastric fluid.

Gastric port 605 may be configured to connect to a gastronomy feeding tube. The gastronomy feeding tube may be a medical-grade feeding tube instead of a simulated feeding tube. In some aspects, gastronomy feeding tube may have a size between 15-25 Fr. Gastronomy assembly 315 is configured to allow a user to make several different evaluations of the system and placement of components such as a gastronomy feeding tube. For example, a user may check placement of gastronomy feeding tube when connected to the gastric port 605. To verify placement and/or patency of the feeding tube, a user may inject air and listen for audible “woosh” sound indicative of air passing through a gastronomy feeding tube. In some instances, a user may utilize a stethoscope placed on the abdomen of the patient simulator to listen for audible sounds after air injection into a feeding tube.

Colostomy port 610 may be configured to connect to a colostomy bag. In some aspects, a colostomy bag may hold between 1.2-1.6 L of gastric fluid.

Referring to FIG. 7, shown therein is a plurality of exploded views of a gastronomy assembly, according to one or more aspects of the present disclosure. FIG. 7 includes gastric port 705, double-o ring 710, gastric port hollow 715, colostomy port bracket 720, gastric reservoir bracket 725, gastric reservoir adapter 730, gastric reservoir 735, barb fitting 740, gastric reservoir plug 745, valve 750, colostomy port 755. In some instances, gastric port 705, double-o ring 710, gastric port hollow 715, colostomy port bracket 720, gastric reservoir bracket 725, gastric reservoir adapter 730, gastric reservoir 735, barb fitting 740, gastric reservoir plug 745, valve 750, colostomy port 755 may be assembled as shown in FIG. 7. In some aspects, gastric reservoir bracket 725 is attached to the simulated torso as shown in FIG. 3.

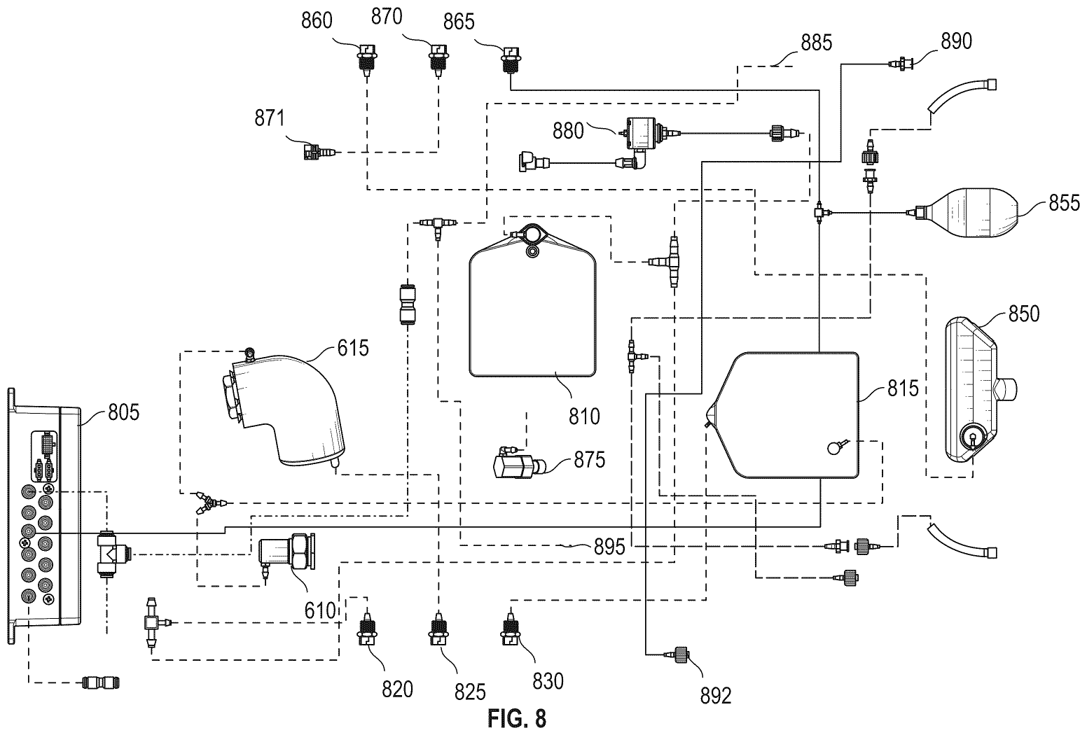

Referring to FIG. 8, shown therein is a schematic diagram of the pneumatics of a gastronomy assembly, according to one or more aspects of the present disclosure. FIG. 8 includes a valve box 805, a gastric reservoir 615, colostomy port 610, intestine bag 810, colostomy bag 815, urinary system 850, CO2 reservoir 855, stomach drainage port 820, gastrostomy drainage port 825, colostomy drainage port 830, rectum valve 875, stomach valve 880, bladder filling/drainage port 860, central line filling/drainage port 870, CO2 option connection port 865, air compressor connection 885, pedal pulse connection 890, MFPP valve connection 892, breathing valve 895, and a plurality of tubing and fittings to interconnect the components of the gastric and/or colostomy system. In some instances, the components previously listed may be connected as shown in FIG. 8. Valve box 805 is configured to open/close, or otherwise control the flow of gases and liquid through the gastronomy assembly and/or the remainder of the patient simulator.

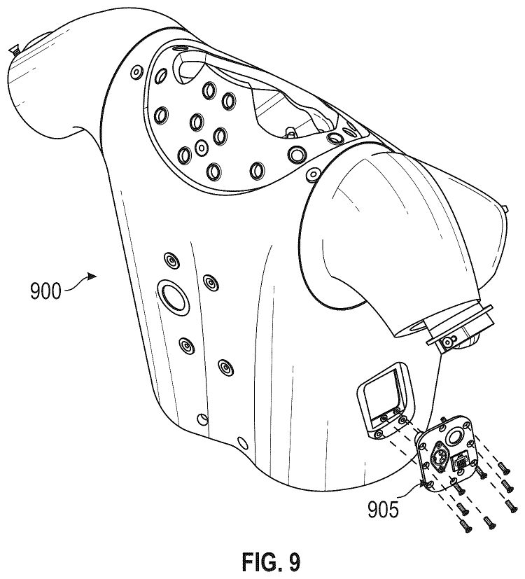

Referring to FIG. 9, shown therein is a perspective view of a portion of a patient simulator, according to one of more aspects of the present disclosure. FIG. 9 depicts an upper torso 900 of a patient simulator. In some instances, a power plate assembly 905 may be fastened to the right side of the upper torso 900.

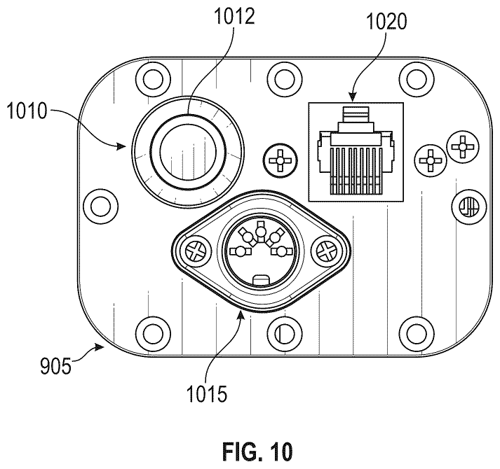

Referring to FIG. 10, shown therein is a perspective view of a power plate assembly 905, according to one or more aspects of the present disclosure. Power plate assembly 905 may include power controller, power indicator, and one or more connectors. In some aspects, power controller may be a push button 1010, power indicator may be a ring light 1012, and one or more connectors may be a first connector 1015 and a second connector 1020. Components of the power plate assembly may be configured within a power plate which attaches the torso of a patient simulator. In some instances, first connector 1015 may be a straight pin connector. In some instances, second connector 1020 may be a jack connector. Push button 1010 may be configured for power control of the patient simulator, and ring light 1012 may indicate a power level. Power plate assembly may be connected to a battery or power source for the patient simulator.

In some instances, push button 1010 may be configured to allow a user to turn on/awaken a patient simulator when pressed. Push button 1010 may be configured to allow a user to determine the status of a battery. Push button 1010 may be configured to allow a user to change a type of communication between the simulator and software. In some instances, the push button 1010 may further comprise a light 1012. Light 1012 may be an RGB ring light The color and lighting sequence of the light may communicate a number of possible things. For example, the color (e.g., green, yellow, or red) may indicate the battery's charge status, blinking may indicate the simulator is attempting to connect to a local computer or other device and continuous emission of light may occur when connection is established, color may indicate the type of communication (e.g., blue for Bluetooth and magenta for RF), red flashing light may indicate critical failure or error in the patient simulator, such as a short circuit.

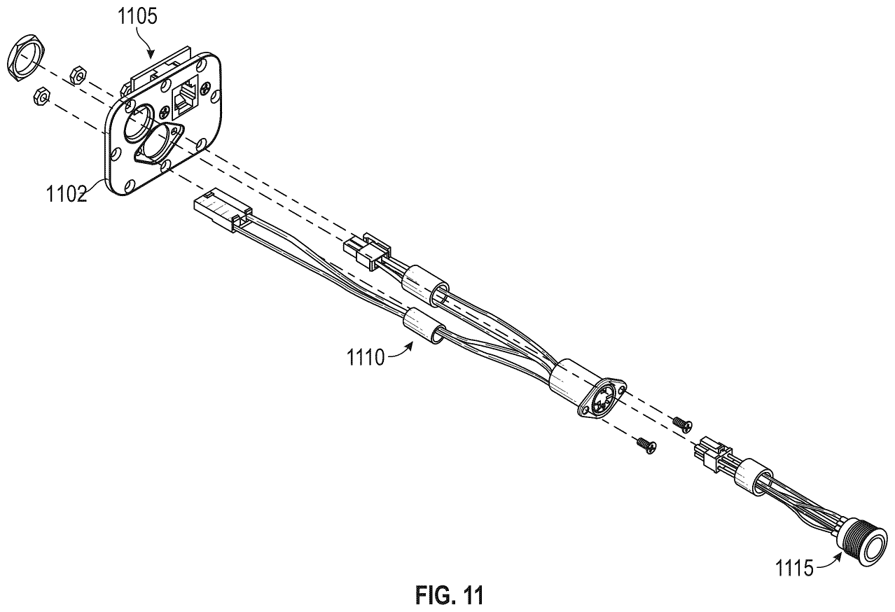

Referring to FIG. 11, shown therein is an exploded view of a power plate assembly, according to one or more aspects of the present disclosure. FIG. 11 includes a power plate 905, a board assembly 1105, a power assembly 1110, and a push button assemble 1115. In some instances, a power plate 1102, a board assembly 1105, a power assembly 1110, and a push button assembly 1115 are assembled as shown in FIG. 11.

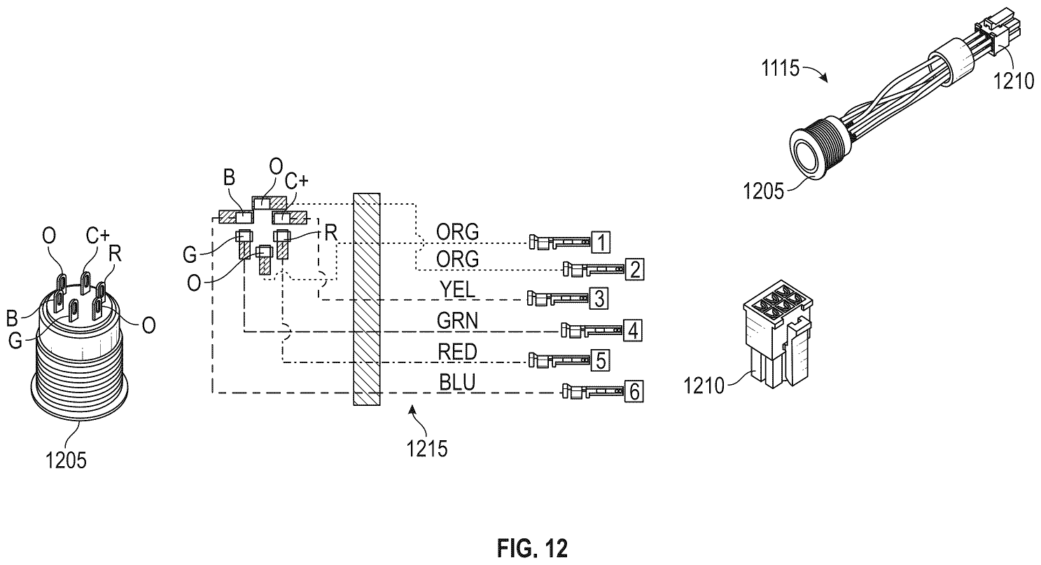

Referring to FIG. 12, shown therein is plurality of views of a push button assembly, according to one of more aspects of the present disclosure. Push button assembly 1115 includes a push button 1205, connector 1210, and a plurality of wires which may connect push button 1205 and connector 1210. In some instances, a plurality of wires connects the push button 1205 and the connector 1210 according to a wiring diagram 1215.

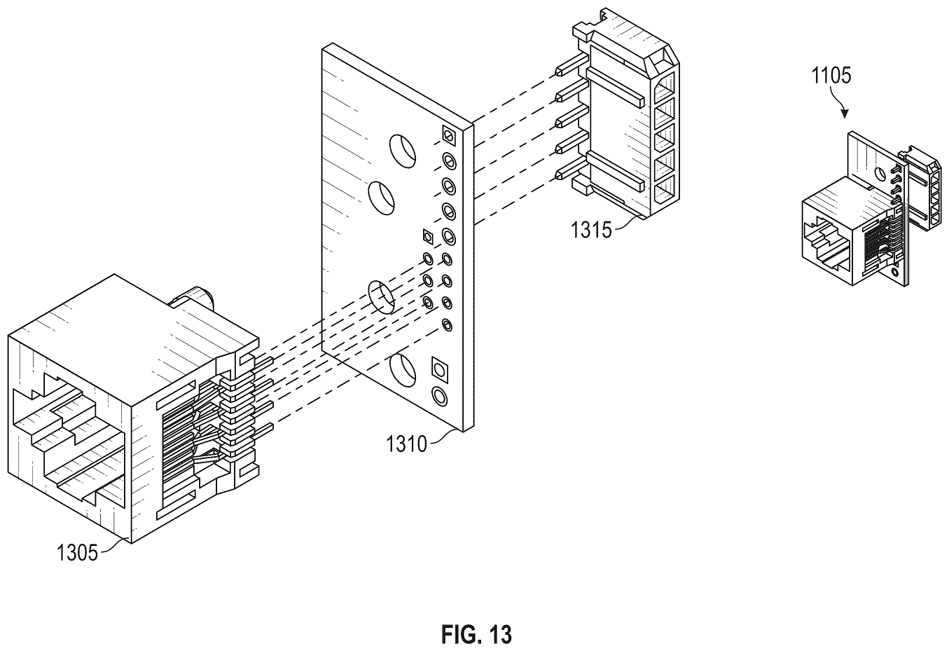

Referring to FIG. 13, shown therein is an exploded view of a board assembly 1105, according to one or more aspects of the present disclosure. FIG. 13 includes a jack connector 1305, circuit board 1310, and header connector 1315. In some instances, a jack connector 1305, circuit board 1310, and header connector 1315 may assembled as shown in FIG. 13. In some instances, board assembly 1105 provides another means of communication with an external device.

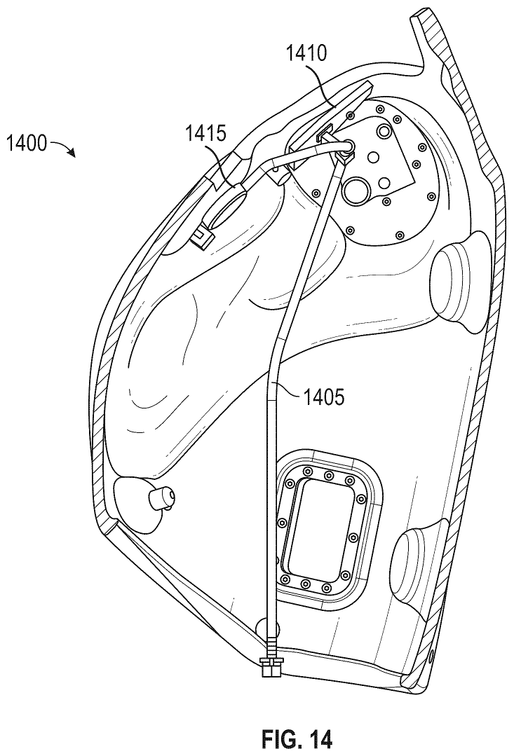

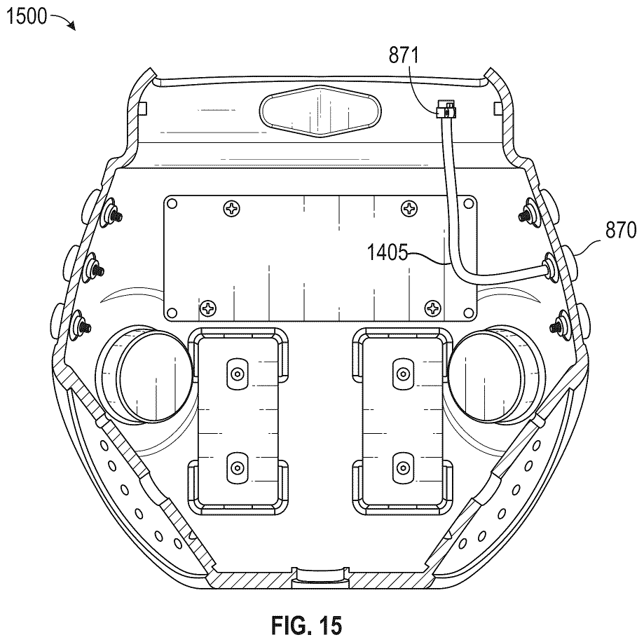

Referring to FIG. 14, shown therein is a cross-sectional side view of a portion of a patient simulator, according to one of more aspects of the present disclosure. FIG. 14 depicts the cross-section through the sagittal plane of an upper torso 1400. In some instances, a central venous line assembly 1405 may be partially disposed within the interior cavity of the upper torso 1400. A central venous line may connect to a portion in the lower torso, as depicted in and described with respect to FIG. 15, below. A central venous line may allow a user to practice realistic placement and use of a simulated catheter for sterile dressing changes, flushing, and simulated medication administration. In some instances, central venous line may be used for continuous infusion. In some aspects, blood may be drawn during a simulation through the central venous line. A central venous line assembly 1405 may include a first port 1415 and a fluid reservoir 1410 within the upper torso of the patient simulator. In some aspects, first port 1415 may include a subclavian insert grommet.

Referring to FIG. 15, shown therein is a cross-sectional view of a central venous line in the lower torso of a patient simulator, according to one or more aspects of the present disclosure. The interior of a lower torso 1500 of a patient simulator may comprise a central line 1405. In some instances, the central line 1405 connects, e.g., via connector 871, to the portion of central line disposed in the interior of the upper torso, as described with respect to FIG. 14. The lower torso 1500 may also include a central line drainage/filling port 870, which allows for continuous draw (such as a blood draw) or continuous infusion (such as medication delivery).

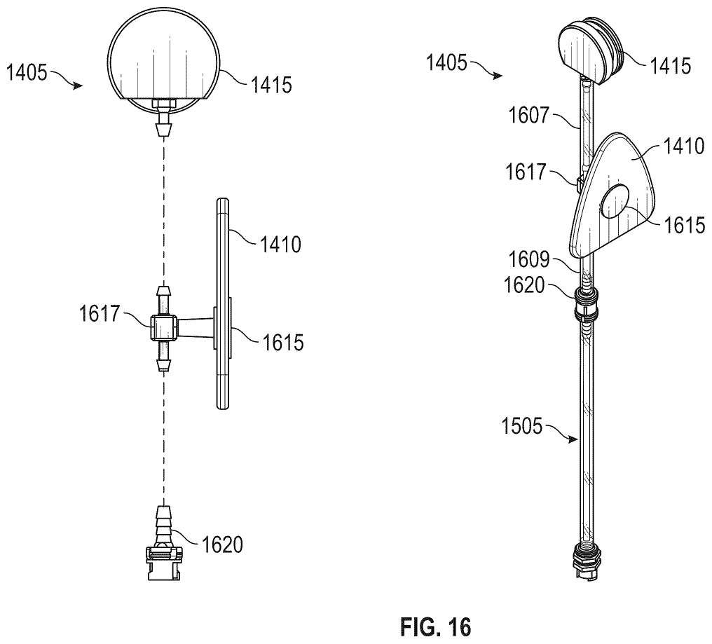

Referring to FIG. 16, shown therein is a perspective view of a central venous line assembly, according to one or more aspects of the present disclosure. FIG. 15 depicts a central venous line 1405 including an insert grommet 1415, tubing 1607 and 1609, sealed fluid reservoir 1410, adhesive 1615, and fittings 1617 and 1620. In some instances, an insert grommet 1415, tubing 1607 and 1609, sealed fluid reservoir 1410, adhesive 1615, and fittings 1617 and 1620 are assembled as shown in FIG. 16. The lower portion 1505 of central venous line 1405 may correspond to another portion of a central venous line disposed in a lower torso of a patient simulator, as described above with respect to FIG. 15. The portion of central venous line assembly 1405 in the upper and lower torso may connected using a fitting 1620 which is configured to be separable.

In some aspects, sealed fluid reservoir 1410 may be configured to store infusions passing through an insert grommet 1415 and flowing down a tube 1607. Infusions, such as intravenous fluids, may be delivered to the patient simulator through a central line insert assembly discussed below. Sealed fluid reservoir 1410 may be in fluid communication with tubing 1607 through a fitting 1617. Consequently, fluid reservoir 1410 may also be in fluid communication with both the first port 1415 and/or second port, e.g., central line drainage/filling port 870. Sealed reservoir 1410 may be attached to an inner wall of a simulated upper torso through adhesive 1615 or other means. In some aspects, sealed reservoir may be configured to hold 5-25 mL of fluid, either to drawn out of the patient simulator by user or inserted into a patient simulator by a user.

In some aspects, central venous line assembly 1405 is configured to allow fluid communication between a first port 1415 and a second port, e.g., central line drainage/filling port 870. In some aspects, fluids introduced or removed from the patient simulator through the central venous line assembly may include, simulated medication, flushing fluid, simulated blood, etc.

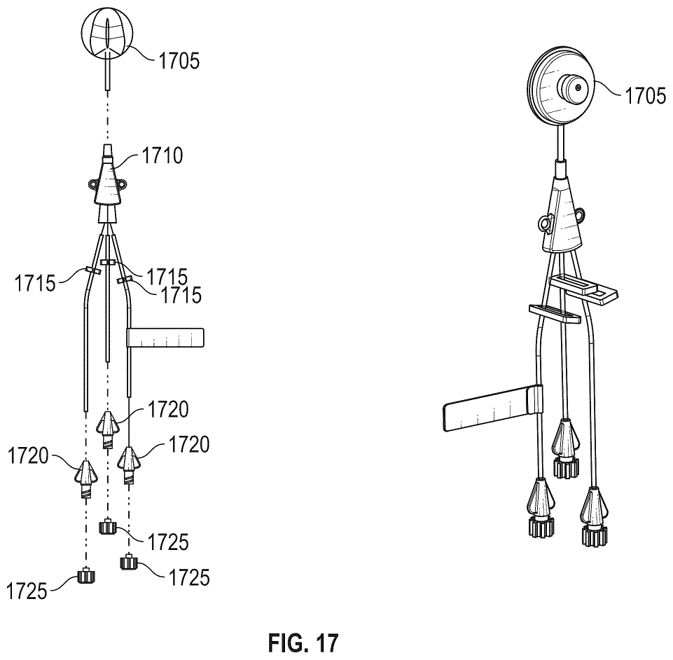

Referring to FIG. 17, shown therein is a perspective view of a multi-lumen central line insert assembly, according to one or more aspects of the present disclosure. FIG. 17 includes a subclavian insert 1705, triple lumen catheter 1710, clamps 1715, luer connectors 1720, luer caps 1725, and a plurality of tubing. In some instances, a subclavian insert 1705, triple lumen catheter 1710, clamps 1715, luer connectors 1720, luer caps 1725, and a plurality of tubing may be assembled as shown in FIG. 17. In some instances, the subclavian insert 1705 is configured to connect to insert grommet 1605 depicted in FIG. 16. A multi-lumen central line insert allows a user during a simulation to practice delivering multiple medications simultaneously or for varying lengths of time and combinations. In some aspects, a central line insert assembly may include 1, 2, 3, 4, . . . 10 lumens.

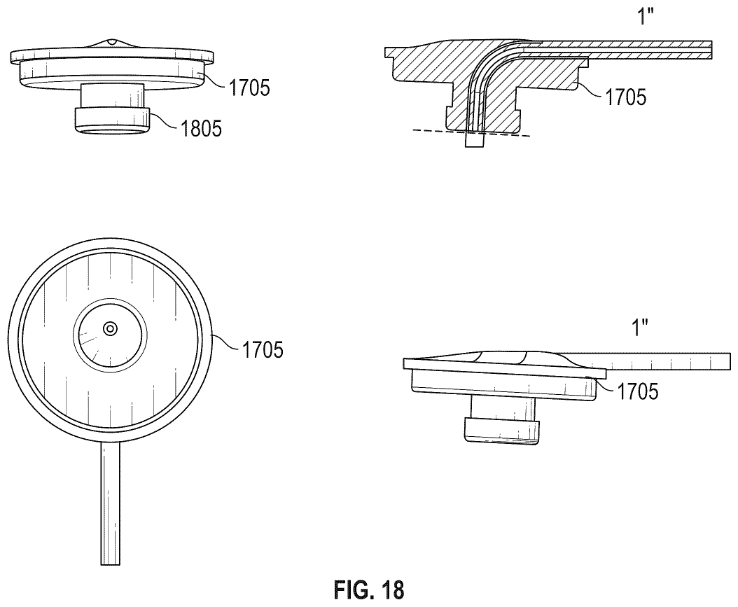

Referring to FIG. 18, shown therein is a plurality of views of a subclavian insert 1705, according to one or more aspects of the present disclosure. FIG. 18 depicts a first side view, cross-sectional view, second side view, and bottom view of a subclavian insert. In some instances, the subclavian insert connects to a central venous line grommet of a patient simulator. The subclavian insert allows a user to deliver or remove fluids from the central venous line disposed in the interior of the torso of a patient simulator. When the central line insert assembly is connected to the subclavian insert grommet fluids may be introduced or removed from the simulated central venous line. In some aspects, subclavian insert connected to a subclavian insert grommet by a snap-on connection. Ridge 1805 may be slightly larger in diameter than the equivalent mating connection on the subclavian insert grommet, allowing ridge 1805 to snap through the subclavian insert grommet after sufficient force is applied.

The following includes aspects of the present disclosure to provide an understanding of the discussed technology. This following is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure.

In one general aspect, the present disclosure is directed to a neck assembly for a patient simulator. The neck assembly also includes a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In some aspects, implementations may include one or more of the following features. The neck assembly where the first portion is configured to be fastened to a simulated torso of the patient simulator. The first joint is restricted to rotate through a total angle of less than 180 degrees. The second joint is restricted to rotate through a total angle of less than 180 degrees. The third joint is restricted to rotate through a total angle of less than 200 degrees. The first joint, second joint, and third joint are configured to be selectively actuated. The neck assembly is configured for an adult-sized patient simulator or a child-size patient simulator.

In one general aspect, the present disclosure is directed to a patient simulator. The patient simulator also includes a simulated head; a simulated torso; and a neck assembly, including: a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In some aspects, implementations may include one or more of the following features. The patient simulator where the first portion is configured to be fastened to a simulated torso of the patient simulator. The first joint is restricted to rotate through a total angle of less than 180 degrees. The second joint is restricted to rotate through a total angle of less than 180 degrees. The third joint is restricted to rotate through a total angle of less than 200 degrees. The first joint, second joint, and third joint are configured to be selectively actuated. The neck assembly is configured for an adult-sized patient simulator or a child-sized patient simulator.

In one general aspect, the present disclosure is directed to a method for assembling a patient simulator. The method also includes connecting a neck assembly to simulated head of the patient simulator; and connecting the neck assembly to a simulated torso of the patient simulator, where the neck assembly includes: a first portion, a second portion, and a third portion, where the first portion that may include a first joint, where the first joint is rotatable around a first axis to cause movement of the simulated head in a frontal plane of the patient simulator, where the second portion is connected to the first portion, where the connection between the second portion and the first portion that may include a second joint, where the second joint is rotatable around a second axis to cause movement of the simulated head in a sagittal plane, and where the third portion is connected to the second portion, where the third portion that may include a third joint, where the third joint is rotatable around a third axis to cause movement of the simulated head in a transverse plane, where the third portion is fastened to the simulated head.

In some aspects, implementations may include one or more of the following features. The method where the first portion is configured to be fastened to a simulated torso of the patient simulator. The first joint is restricted to rotate through a total angle of less than 180 degrees. The second joint is restricted to rotate through a total angle of less than 180 degrees. The third joint is restricted to rotate through a total angle of less than 200 degrees. The first joint, second joint, and third joint are configured to be selectively actuated.

In one general aspect, the present disclosure is directed to a hip assembly for a patient simulator. The hip assembly also includes a first portion and a second portion, where the first portion is mounted to a simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg portion in a frontal plane of the patient simulator, and where the second portion that may include a second joint, where the second joint is configured to rotate around a third axis to cause movement of the simulated leg portion in a transverse plane.

In some aspects, implementations may include one or more of the following features. The hip assembly where the hip assembly is actuatable at the first joint, second joint, and third joint to allow the patient simulator to be configured for placement into medical stirrups. The hip assembly is actuatable at the first joint, second joint, and third joint to allow the patient simulator to cross a left simulated leg and a right simulated leg. The hip assembly is actuatable at the first joint, second joint, and third joint to allow the patient simulator to be configured into a seating position. The hip assembly is sized for an infant patient simulator. The hip assembly is sized for an adult patient simulator. The hip assembly is sized for a child patient simulator.

In one general aspect, the present disclosure is directed to a patient simulator. The patient simulator also includes a simulated torso; and a simulated leg, where the simulated leg includes a hip assembly configured to control positioning and orientation of the simulated leg, where the hip assembly includes: a first portion and a second portion, where the first portion is mounted to the simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg in a frontal plane of the patient simulator, and where the second portion that may include a second joint, where the second joint is configured to rotate around a third axis to cause movement of the simulated leg portion in a transverse plane.

In some aspects, implementations may include one or more of the following features. The patient simulator where the hip assembly is actuatable at the first joint, second joint, and third joint to allow the patient simulator to be configured for placement into medical stirrups. The hip assembly is actuatable at the first joint, second joint, and third joint to allow the patient simulator to cross a left simulated leg and a right simulated leg. The hip assembly is actuatable at the first joint, second joint, and third joint to allow the patient simulator to be configured into a seating position. The hip assembly is sized for an infant patient simulator. The hip assembly is sized for an adult patient simulator. The hip assembly is sized for a child patient simulator.

In one general aspect, the present disclosure is directed to a method for assembling a patient simulator. The method also includes connecting a first portion of a hip assembly within a simulated leg to a simulated torso of the patient simulator, where the hip assembly is configured to control positioning and orientation of the simulated leg and includes: a first portion and a second portion, where the first portion is mounted to the simulated torso of the patient simulator, where the second portion is connected to the first portion, where the first portion that may include a first joint, where the first joint is configured to rotate around a first axis to cause movement of the simulated leg portion in a sagittal plane of the patient simulator and second axis to cause movement of the simulated leg in a frontal plane of the patient simulator, and where the second portion that may include a second joint, where the second joint is configured to rotate around a third axis to cause movement of the simulated leg portion in a transverse plane.

In some aspects, implementations may include one or more of the following features. The method where the hip assembly is actuatable at the first joint, second joint, and third joint to allow the patient simulator to be configured for placement into medical stirrups. The hip assembly is actuatable at the first joint, second joint, and third joint to allow the patient simulator to cross a left simulated leg and a right simulated leg. The hip assembly is actuatable at the first joint, second joint, and third joint to allow the patient simulator to be configured into a seating position. The hip assembly is sized for a child patient simulator. The hip assembly is sized for an adult patient simulator.

In one general aspect, the present disclosure is directed to a gastronomy assembly for a patient simulator. The gastronomy assembly also includes a gastric reservoir bracket configured to be attached to an internal wall of a simulated torso of the patient simulator; a gastric reservoir connected to the bracket and configured to store simulated gastric fluids, and a gastric port connected to the gastric reservoir and configured to allow simulated gastric fluids to pass through the gastric port into the gastric reservoir.

In some aspects, implementations may include one or more of the following features. The gastronomy assembly where the gastric port is configured to connect to a gastronomy feeding tube. The gastronomy assembly may include: a colostomy port bracket affixed to the gastric reservoir bracket and a colostomy port connected to the colostomy port bracket. The colostomy port is configured to connect to a colostomy bag. The gastronomy assembly is configured to allow a user to check placement of the gastronomy feeding tube. The gastronomy assembly is configured to allow a user to hear a sound when air is passed through the gastronomy feeding tube. The gastric port is configured to connect to a gastronomy feeding tube of size 18-22 Fr. The gastric reservoir is configured to store between 60-80 mL of gastric fluid.

In one general aspect, the present disclosure is directed to a patient simulator. The patient simulator also includes a simulated torso and a gastronomy assembly mounted to an internal wall of the simulated torso, the gastronomy assembly including: a gastric reservoir bracket connected to an internal wall of a simulated torso of the patient simulator; a gastric reservoir affixed to the bracket and configured to store simulated gastric fluids; and a gastric port connected to the gastric reservoir and configured to allow simulated gastric fluids to pass through the gastric port into the gastric reservoir.

In some aspects, implementations may include one or more of the following features. The patient simulator where the gastric port is configured to connect to a gastronomy feeding tube. The patient simulator may include: a colostomy port bracket affixed to the gastric reservoir bracket and a colostomy port connected to the colostomy port bracket. The colostomy port is configured to connect to a colostomy bag. The gastronomy assembly is configured to allow a user to check placement of the gastronomy feeding tube. The gastronomy assembly is configured to allow a user to hear a sound when air is passed through the gastronomy feeding tube. The patient simulator may include: a gastronomy feeding tube connected to the gastric port. The patient simulator is configured to allow a user to check patency of the gastronomy feeding tube. The patient simulator is configured to allow a user to check placement of the gastronomy feeding tube. The colostomy bag holds between 1.3-1.5 L of gastric fluid. The gastric port is configured to connect to a gastronomy feeding tube of size 18-22 Fr. The gastric reservoir is configured to store between 60-80 mL of gastric fluid.

In one general aspect, the present disclosure is directed to a power plate assembly for a patient simulator. The power plate assembly also includes a power plate; a power controller affixed to the power plate. The power plate assembly also includes a power indicator affixed to the power plate; and one or more mating connectors to receive one or more connectors, the one or more mating connectors affixed to the power plate. The power plate assembly also includes where the one or more connectors include a connector configured to establish communication between the patient simulator and a computing device.

In some aspects, implementations may include one or more of the following features. The power plate assembly where the power controller is configured to cause one or more actions when engaged by a user, the one or more actions including: turning on or off the patient simulator; determining a status of a battery configured to power the patient simulator; or changing a form of communication between the patient simulator and a computing device. The power indicator is configured to indicate one or more of the following: indicate battery status charge; indicate status of a communication link with a computing device between the patient simulator and the computing device; indicate a type of communication; or indicate if an error has occurred in the patient simulator. The power indicator that may include a light source configured to emit light of a plurality of colors and a plurality of light emission configurations. The plurality of colors include at least four colors and the plurality of light emission configurations include at least two configurations. The at least two configurations include blinking and continuous emission. Battery charge status that may include a plurality of statuses associated with one or more of the plurality of colors. The type of communication includes a first type and a second type, the first type and second type associated with a first color and second color in the plurality of colors. The status of a communication link includes a first status and a second status, the first status and second status associated with a first light emission configuration and a second light emission configuration in the plurality of light emission configurations. The power plate assembly an error occurring in the patient simulator is indicated by a first color in the plurality of colors and a first light emission configuration in the plurality of light emission configurations.

In one general aspect, the present disclosure is directed to a patient simulator. The patient simulator also includes a battery disposed within the patient simulator; a simulated torso. The patient simulator also includes a power plate assembly mounted on the simulated torso and connected to the battery, that may include: a power plate; a power controller affixed to the power plate; a power indicator affixed to the power plate; and one or more mating connectors to receive one or more connectors, the one or more mating connectors affixed to the power plate, where the one or more connectors include a connector configured to establish communication between the patient simulator and a computing device.

In some aspects, implementations may include one or more of the following features. The patient simulator where the power controller is configured to cause one or more actions when engaged by a user, the one or more actions including: turning on or off the patient simulator; determining a status of a battery configured to power the patient simulator; or changing a form of communication between the patient simulator and a computing device. The power indicator is configured to indicate one or more of the following: indicate battery status charge; indicate status of a communication link with a computing device between the patient simulator and the computing device; indicate a type of communication; or indicate if an error has occurred in the patient simulator. The power indicator that may include a light source configured to emit light of a plurality of colors and a plurality of light emission configurations. The plurality of colors include at least four colors and the plurality of light emission configurations include at least two configurations. The at least two configurations include blinking and continuous emission. Battery charge status that may include a plurality of statuses associated with one or more of the plurality of colors. The type of communication includes a first type and a second type, the first type and second type associated with a first color and second color in the plurality of colors. The status of a communication link includes a first status and a second status, the first status and second status associated with a first light emission configuration and a second light emission configuration in the plurality of light emission configurations. The patient simulator an error occurring in the patient simulator is indicated by a first color in the plurality of colors and a first light emission configuration in the plurality of light emission configurations.

In one general aspect, the present disclosure is directed to a central venous line assembly configured for placement in an internal cavity of a simulated torso of a patient simulator. The central venous line assembly also includes a first port; a simulated catheter that may include a tube connected at a first end to the first port; and a second port connected to a second end of the tube, where the central venous line assembly is configured to allow fluid communication between the first port and the second port.

In some aspects, implementations may include one or more of the following features. The central venous line assembly where the first port is configured to allow fluid to enter the simulated catheter at the first end. The fluid is one of simulated medication, flushing fluid, or simulated blood. The second port is configured to allow to fluid leave the simulated catheter at the second end. The central venous line assembly may include a fluid reservoir in fluid communication with the simulated catheter. The fluid reservoir is in fluid communication with the first port. The fluid reservoir is configured to store between 5-25 mL of fluid.

In one general aspect, the present disclosure is directed to a patient simulator a simulated torso including: a first port, and a second port. The patient simulator also includes a central venous line assembly configured for placement in an internal cavity of the simulated torso, including: a simulated catheter that may include a tube, where a first end of the tube is connected to the first port of the simulated torso, and where a second end of the tube is connected to second port of the simulated torso, where the central venous line assembly is configured to allow fluid communication between the first port and the second port.

In some aspects, implementations may include one or more of the following features. The patient simulator where the first port is configured to allow fluid to enter the simulated catheter at the first end. The fluid is one of simulated medication, flushing fluid, or simulated blood. The second port is configured to allow to fluid leave the simulated catheter at the second end. The first port that may include a subclavian insert grommet. The plurality of tubing includes a plurality of lumens, plurality of luer caps and a plurality of luer connectors connected to the plurality of tubing. The plurality of lumens is a single lumen. The plurality of lumens is three lumens. The central line insert assembly is configured to deliver simulated medication to the first port of the simulated torso. The subclavian insert is configured to connect to the subclavian insert grommet through a snap-on mechanism. The patient simulator may include a fluid reservoir in fluid communication with the simulated catheter. The fluid reservoir is in fluid communication with the first port. The fluid reservoir is configured to store between 5-25 mL of fluid.

Although illustrative aspects have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the aspects. Accordingly, it is appropriate that the appended claims be construed broadly and in a manner consistent with the scope of the present disclosure.

1. A neck assembly for a patient simulator, the neck assembly configured to control an orientation of a simulated head of the patient simulator, comprising:
a first portion, a second portion, and a third portion,
wherein the first portion comprises a first joint, wherein the first joint is rotatable around a first axis to cause movement of the simulated head in a frontal plane of the patient simulator,
wherein the second portion is connected to the first portion, wherein the connection between the second portion and the first portion comprises a second joint, wherein the second joint is rotatable around a second axis to cause movement of the simulated head in a sagittal plane, and
wherein the third portion is connected to the second portion, wherein the third portion comprises a third joint, wherein the third joint is rotatable around a third axis to cause movement of the simulated head in a transverse plane, wherein the third portion is fastened to the simulated head.

2. The neck assembly of claim 1, wherein the first portion is configured to be fastened to a simulated torso of the patient simulator.

3. The neck assembly of claim 1, wherein the first joint is restricted to rotate through a total angle of less than 180 degrees.

4. The neck assembly of claim 1, wherein the second joint is restricted to rotate through a total angle of less than 180 degrees.

5. The neck assembly of claim 1, wherein the third joint is restricted to rotate through a total angle of less than 200 degrees.

6. The neck assembly of claim 1, wherein the first joint, second joint, and third joint are configured to be selectively actuated.

7. The neck assembly of claim 1, wherein the neck assembly is configured for an adult-sized patient simulator or a child-size patient simulator.

8. A hip assembly for a patient simulator, the hip assembly configured to control positioning and orientation of a simulated leg portion of a patient simulator, comprising:
a first portion and a second portion,
wherein the first portion is mounted to a simulated torso of the patient simulator,
wherein the second portion is connected to the first portion,
wherein the first portion comprises a first joint, wherein the first joint is configured to rotate around a first axis to cause movement of the simulated leg portion in a sagittal plane of the patient simulator and second axis to cause movement of the simulated leg portion in a frontal plane of the patient simulator, and
wherein the second portion comprises a second joint, wherein the second joint is configured to rotate around a third axis to cause movement of the simulated leg portion in a transverse plane.

9. The hip assembly of claim 8, wherein the hip assembly is actuatable at the first joint, second joint, and third joint to allow the patient simulator to be configured for placement into medical stirrups.

10. The hip assembly of claim 8, wherein the hip assembly is actuatable at the first joint, second joint, and third joint to allow the patient simulator to cross a left simulated leg and a right simulated leg.

11. The hip assembly of claim 8, wherein the hip assembly is actuatable at the first joint, second joint, and third joint to allow the patient simulator to be configured into a seating position.

12. The hip assembly of claim 8, wherein the hip assembly is sized for an infant patient simulator.

13. The hip assembly of claim 8, wherein the hip assembly is sized for an adult patient simulator.

14. The hip assembly of claim 8, wherein the hip assembly is sized for a child patient simulator.

15. A gastronomy assembly for a patient simulator, comprising:
a gastric reservoir bracket configured to be attached to an internal wall of a simulated torso of the patient simulator;
a gastric reservoir connected to the bracket and configured to store simulated gastric fluids; and
a gastric port connected to the gastric reservoir and configured to allow simulated gastric fluids to pass through the gastric port into the gastric reservoir.

16. The gastronomy assembly of claim 15, wherein the gastric port is configured to connect to a gastronomy feeding tube.

17. The gastronomy assembly of claim 15, wherein the gastric port is configured to connect to a gastronomy feeding tube of size 18-22 Fr.

18. The gastronomy assembly of claim 16, further comprising:
a colostomy port bracket affixed to the gastric reservoir bracket,
a colostomy port connected to the colostomy port bracket.

19. A power plate assembly for a patient simulator, comprising:
a power plate;
a power controller affixed to the power plate;
a power indicator affixed to the power plate; and
one or more mating connectors to receive one or more connectors, the one or more mating connectors affixed to the power plate,
wherein the one or more connectors include a connector configured to establish communication between the patient simulator and a computing device.

20. A central venous line assembly configured for placement in an internal cavity of a simulated torso of a patient simulator, comprising:
a first port;
a simulated catheter comprising a tube connected at a first end to the first port; and
a second port connected to a second end of the tube,
wherein the central venous line assembly is configured to allow fluid communication between the first port and the second port.
